(19) United States
(12) Patent Application Publication
(10) Pub. No.: US 2009/0037163 A1
(43) Pub. Date: Feb. 5, 2009

(54) Fast and Flexible Communication System Simulation

(76) Inventors: Hong Wei Kong, Beijing (CN); Honggang Zhang, Beijing (CN); Ya Jing, Beijing (CN); Ziquan Bai, Beijing (CN)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/830,187

(22) Filed: Jul. 30, 2007

(51) Int. Cl. G06F 9/44

(52) U.S. Cl. 703/21

(57) ABSTRACT

A simulation system for a communication system includes a user interface to receive user definition and system configuration parameters of a simulation configuration file that includes a plurality of data structures representing various functional modules of the simulated communication system. A model library is provided to store different implementation models corresponding to different communication standards for each of the functional modules. A parsing module accesses the model library according to the user definition and system configuration parameters to obtain the appropriate implementation model for each of the functional modules, and generates a simulated system program based on the selected implementation models such that the simulated system program is reconfigurable to different implementations and communication standards. A simulation engine runs the simulated system program to simulate the simulated communication system. A simulated system program generation system is also described.

### TECHNICAL FIELD

The technical field of the invention relates to seamlessly simulating different communication system designs under different communication standards using a single simulation system to achieve fast and flexible communication system simulation.

### BACKGROUND

Currently, a simulation system can be used in communication research to explore system performance of a target communication system being designed and developed. The simulation system is typically designed for simulating a specific type of communication system architecture or for communication systems of a specific communication standard.

FIG. 9 shows one such prior art simulation system 900. In FIG. 9, before simulation, the simulation system 900 receives system configuration parameters of a target communication system to be simulated in a simulation configuration file 902 via a user interface 901. The system configuration parameters typically include maximum transmission rate, maximum transmission power, signal-noise-ratio (SNR) of each channel, and/or other parameters of various functional modules of the simulated communication system. The simulation configuration file 902 is then applied to a simulation engine 905 of the system 900.

The simulation engine 905 includes a parameter setting module 903 that sets the configuration parameters into a simulated system program 904 of the simulation engine 905. The simulated system program 904 is a software program and typically includes all possible functional modules of a specific communication system implementation and/or according to a specific communication standard. This means that the simulated system program 904 is a pre-constructed or pre-configured simulation software program adapted to and pre-constructed or pre-configured to a specific type of communication system implementation and/or to a specific communication standard. This makes the simulated system program 904 is “fixed” or “hard-coded” in the simulation engine 905.

The simulation engine 905 performs the simulation operation by running the simulated system program 904. Then, simulation results are collected and sent to a result post-processing program 906 of the simulation engine 905 for post-processing (e.g., displaying the simulation results).

One disadvantage of this prior art simulation system is that the simulated system program is “fixed” or “hard-coded” in the simulation engine. This means that the structures of the functional modules of the simulated communication system are already pre-determined in the simulated system program. That is, what kind of transmitter, channel and receiver to be used are already predetermined in the simulated system program. The implementations of the functional modules within the simulated system program cannot be changed at run-time. Only the values of the system configuration parameters in some of the fixed functional modules can be changed.

In order to simulate different communication systems with different architectures and/or for different communication standards, the user has to manually redesign or reconfigure the simulated system program. This limits the flexibility and scalability of the simulation system. Thus, what is needed is a flexible and scalable communication simulation system that supports simulation of different communication systems with different structures seamlessly and at run-time.

### SUMMARY

A simulation system for a communication system includes a user interface to receive user definition and system configuration parameters of a simulation configuration file that includes a plurality of data structures representing various functional modules of the simulated communication system. A model library is provided to store different implementation models corresponding to different communication standards for each of the functional modules. A parsing module (1) accesses the model library according to the user definition and system configuration parameters to obtain the appropriate implementation model for each of the functional modules, and (2) generates a simulated system program based on the selected implementation models such that the simulated system program is reconfigurable to different implementations and communication standards. A simulation engine runs the simulated system program to simulate the simulated communication system.

Furthermore, a system for generating a simulated system program for simulating a communication system includes a user interface to receive user definition and system configuration parameters of a simulation configuration file that includes a plurality of data structures representing various functional modules of the simulated communication system. A model library is provided to store different implementation models corresponding to different communication standards for each of the functional modules. A parsing module (1) accesses the model library according to the user definition and system configuration parameters to obtain the appropriate implementation model for each of the functional modules, and (2) generates the simulated system program based on the selected implementation models such that the simulated system program is reconfigurable to different implementations and communication standards.

### BRIEF DESCRIPTION OF THE DRAWINGS

The foregoing and other features of this invention may be more fully understood from the following description, when read together with the accompanying drawings in which:

FIG. 1 illustrates a block diagram of a communication simulation system in accordance with one embodiment of the present invention;

FIG. 2 shows a block diagram of a communication simulation system in accordance with another embodiment of the present invention;

FIG. 3 is a diagram showing the hierarchical structure of a simulation configuration file shown in FIG. 1;

FIG. 4 shows the parsing process of a parsing module shown in FIG. 1 for parsing a phase noise data structure of the simulation configuration file of FIG. 3 as an example;

FIG. 5 shows the structure of a simulated system program of FIG. 1 generated by the parsing module of FIG. 1 in accordance with one embodiment of the present invention;

FIG. 6 shows the process of simulation result collection and post-processing of the simulation system of FIG. 1 after simulation;

FIG. 7 is a flow chart diagram showing the overall simulation process of the simulation system of FIG. 1;

FIG. 8 shows an software and hardware co-simulation arrangement by the simulation system of FIG. 1; and

FIG. 9 shows a prior art communication simulation system.

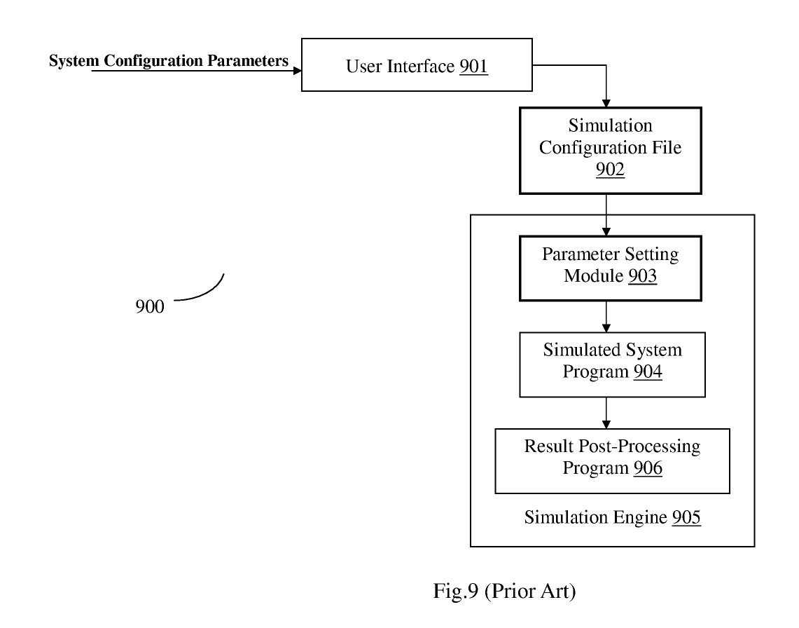

### DETAILED DESCRIPTION

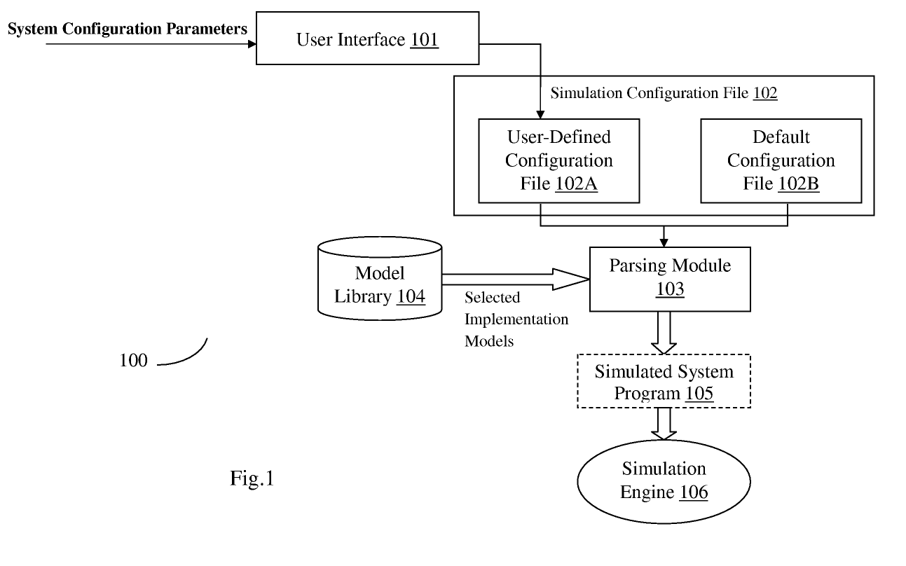

FIG. 1 shows a communication simulation system 100 for simulating a communication system (not shown). In accordance with one embodiment of the present invention, the simulation system 100 is not structured, adapted, or configured to any specific communication system implementation or architecture, or is not following any specific communication protocol standard. This means that the simulation system 100 is a flexible and scalable communication simulation system that supports simulation of different communication systems with different structures or architectures seamlessly and at run-time.

The simulation system 100 achieves this by having its simulated system program 105 not fixed or hard-coded to any specific communication system structure or architecture. In addition, the simulated system program 105 is also not fixed to follow any specific communication protocol standard (or simply communication standard). Instead, the simulated system program 105 initially only has an abstract data structure that represents the functional blocks of an abstract and standard communication system without regard to any communication standard. This abstract communication system, however, does not correspond to any specific implementation or architecture of a communication system. Then at run-time, the simulated system program 105 is configured or reconfigured to the actual and specific implementation or architecture of the simulated communication system based on the user input of the configuration data or information of the simulated communication system.

To configure the simulated system program 105 to represent the simulated communication system, the simulation system 100 includes a user interface 101 that receives the configuration information of the simulated communication system. The configuration information includes user definition and system configuration parameters of the simulated communication system. The user definition includes model implementation information of various functional modules of the simulated communication system, as well as the communication standard adopted by the simulated communication system. The system configuration parameters include various parameters of the simulated communication system, such as maximum transmission rate, maximum transmission power, signal-noise-ratio (SNR) of each channel, and various parameters of each of the functional modules of the simulated communication system.

In addition, the simulation system 100 in accordance with one embodiment of the present invention includes a model library 104 that stores all model implementations of each possible functional module of a communication system, as well as specification data relating to each communication standard. Then at run-time, a simulation system parsing module 103 of the simulation system 100 is used to configure or reconfigure the simulated system program 105 by accessing the model library 104 in accordance with a parsing (by the module 103) of a user-defined configuration file generated based on the user definition and system configuration parameters received via the user input 101.

By decoupling the simulation system with the simulated communication system and decoupling communication standard specifications with algorithm model libraries, the communication simulation system 100 supports simulation of different communication systems with different structures seamlessly and switch to different implementations at run-time. This allows the communication simulation system 100 to achieve flexibility, scalability, and run-time controllability.

The communication simulation system 100 also permits (1) specifying what simulation results are to be collected and (2) changing data analysis methods at run-time. Furthermore, the communication simulation system 100 abstracts the modules composed of the simulated communication system into a number of layered configuration data structures. In this case, the user can easily perform software and hardware co-simulation to achieve the capability of test and verification so as to facilitate fast prototyping.

Detailed description of the communication simulation system 100 in accordance with embodiments of the present invention is given below, in conjunction with FIGS. 1-8. In addition, the below description focuses on simulating a wireless communication system based on the Multiple Input Multiple Output (MIMO) Orthogonal Frequency Division Multiplexing (OFDM) technology as an example. However, it should be noted that the same simulation system can be used for simulating other wire-line or wireless communication systems.

As shown in FIG. 1, the communication simulation system 100 includes the user interface 101, the parsing module 103, the model library 104 and a simulation engine 106. The simulation engine 106 runs the configured or reconfigured simulated system program 105 to simulate the simulated communication system. In accordance with one embodiment of the present invention, the parsing module 103 generates the simulated system program 105. This means that the parsing module 103 configures or reconfigures the simulated system program 105 such that it represents the simulated communication system. This will be described in more detail below.

In addition, the simulation system 100 includes a store (not shown) to store a configuration file 102. The configuration file 102 includes a user-defined configuration file 102A and a default configuration file 102B. The configuration file 102 is generated based on the user input (i.e., user definition and system configuration parameters) via the user input 101 and is used by the parsing module 103 to access the model library 104 in order to generate the simulated system program 105. This makes the simulated system program 105 configurable and reconfigurable according to the structures or architectures of different simulated communication systems. In one embodiment, the user input 101 is a graphic user interface (GUI). Alternatively, the user input 101 can be other known user input apparatus.

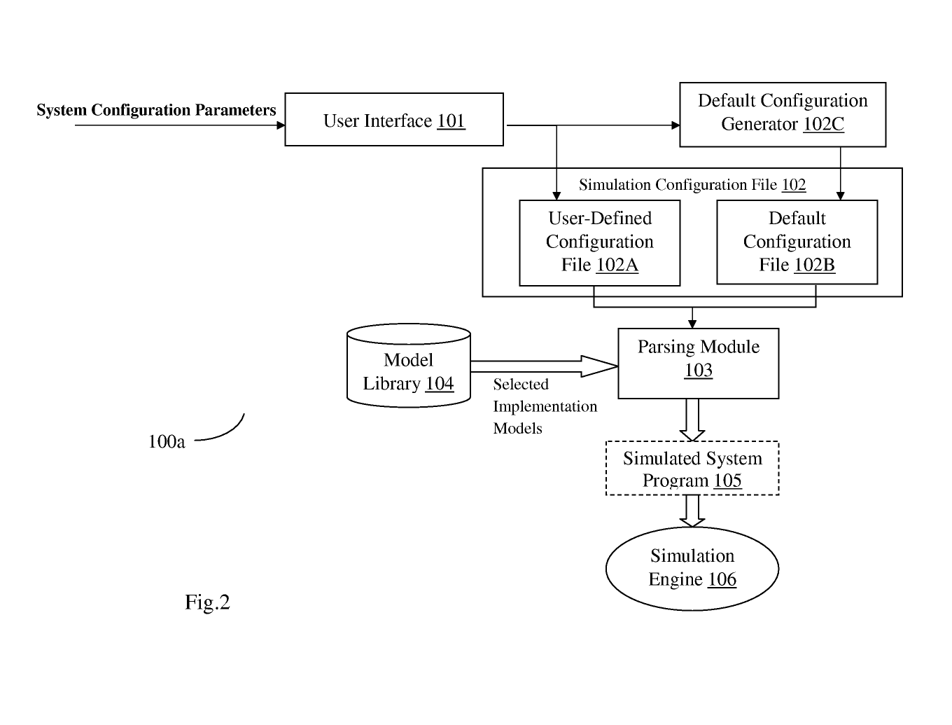

The user-defined configuration file 102A is configured based on the user definition and system configuration parameters received from the user input 101. Because there are many parameters necessary to be configured, it is desirable for the user to be able to specify the parameters they need to control and leave all others to the default values. The default configuration file 102B is provided to achieve this. Here, there are various approaches to specify the default parameters. The first approach is shown in FIG. 1, wherein the default parameters are wrote into the default configuration file 102B. The default configuration file 102B is stored in the simulation system 100 and provides the default parameters. Alternatively, FIG. 2 shows another approach, wherein the user can select to use a default configuration generator 102C to generate the default configuration file 102B. In this case, the user needs only to specify the parameters he cares into the user-defined configuration file 102A and leaves all other parameters to be set to default values specified in the default configuration file 102B.

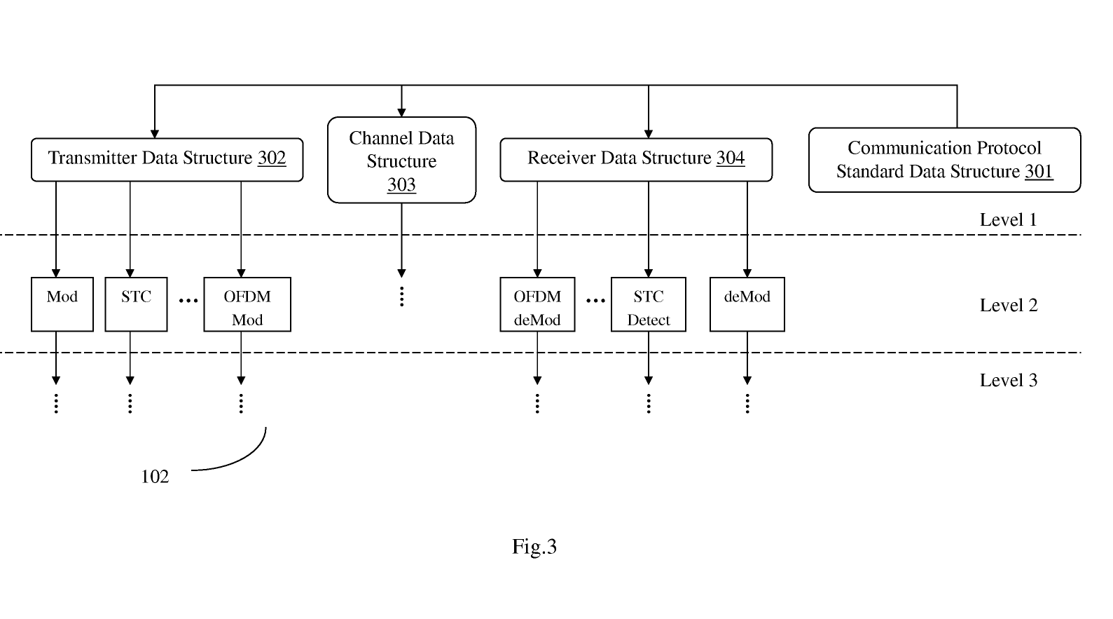

The user-defined configuration file 102A and the default configuration file 102B are combined to form the simulation configuration file 102, which includes all system configuration and performance parameters necessary to determine the structure and implementation of the communication system to be simulated. FIG. 3 shows the structure of the configuration file 102 in accordance with one embodiment of the present invention, which will be described in more detail below.

As shown in FIG. 3, the simulation configuration file 102 includes a plurality of data structures. Each of the data structures is used to represent one of the functional modules composed of the simulated communication system in abstract terms without considering the actual implementation. Then, at run-time, through configuring the values of the fields in the data structures, the user can determine the simulated communication system and the actual implementation to be used for the simulated system. This brings the advantages of flexibility, scalability and run-time controllability to the simulation system 100.

The data structures of the configuration file 102 are layered. This means the structures are arranged in a layered way. As shown in FIG. 3, the top level (i.e., level 1) of the simulation configuration file 102 includes four main data structures, that is, a communication protocol standard data structure 301, a transmitter data structure 302, a channel data structure 303, and a receiver data structure 304. The communication protocol standard data structure 301 includes the specification parameters corresponding to a specific communication protocol standard, such as 802.11a or 802.11n, so as to separate the standard with the module implementations. The information included in the communication protocol standard data structure 301 will be used by the transmitter data structure 302, the channel data structure 303, and the receiver data structure 304 to follow the specific communication protocol standard specification specified in the communication protocol standard data structure 301. This approach makes it possible to use the same model library among different communication standards. For example, it is possible to use the same MIMO OFDM model library among different wireless communication standards adopting MIMO OFDM technology, such as 802.11a and 802.11n standards.

The transmitter data structure 302, the channel data structure 303, and the receiver data structure 304 correspond to the simulated transmitter, the simulated channel, and the simulated receiver respectively. For each of the data structures, in the lower levels, such as level 2 and level 3, they can contain lower children data structures corresponding to the components composed of the parent data structure. The data structure can go further down if the simulated communication system so requires. For example, the transmitter data structure 302 can contain data structures corresponding to modulator, encoder, Digital to Analog (D/A) converter, etc. The modulator data structure can further contain even more data structures, such as Local Oscillator, etc. Similarly, the receiver data structure 304 can contain data structures corresponding to demodulator, decoder, Analog to Digital (A/D) converter, etc.

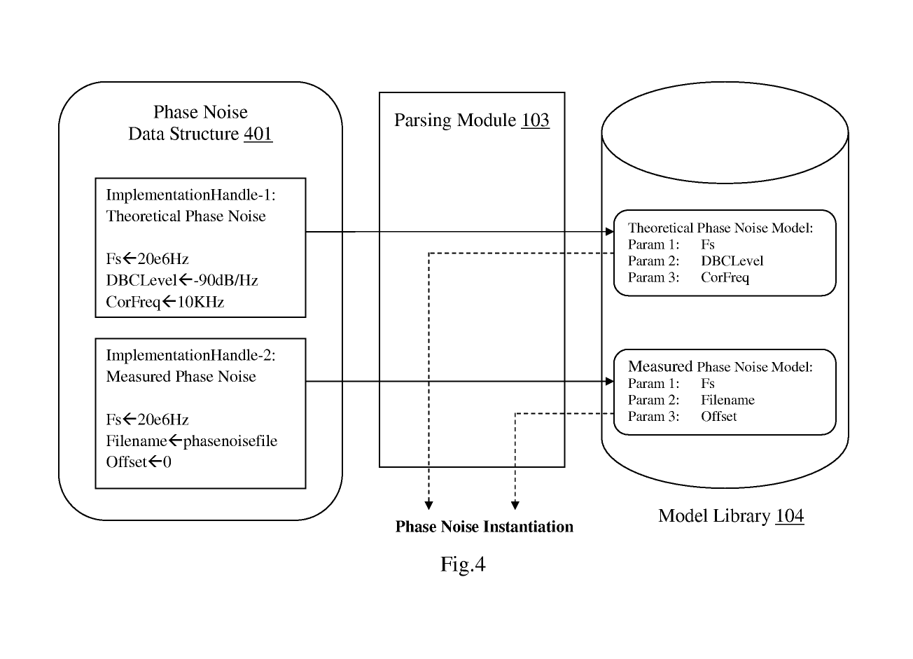

Each data structure includes a specific field ImplementationHandle (not shown), which is used to specify the actual implementation of the corresponding functional module. The switch between different implementations of the same module will be described below with reference to FIG. 4.

Referring again to FIGS. 1 and 3, all the configuration parameters of a specific module are configured inside the corresponding data structure. The user can specify any parameters they want in the data structure as long as the specified implementation of the module understands how to deal with those specified parameters.

To specify the field of a data structure which is several layers below the root data structure, i.e. one of the data structures 301-304, an index is used. The index includes the names of all the parent data structures as well as the name of the field itself. For example, in order to specify the field NumberofBitPerSymbol of a modulator of a transmitter, the index Transmitter_Modulator_NumberofBitPerSymbol is used for the configuration of the corresponding field. Then, the parsing module 103 (FIG. 1) sets the values of the specified parameters according to the above-mentioned grammar. The operation of the parsing module 103 will be described in more detail later, also in conjunction with FIG. 4. However, the grammar for specifying the parameters is not limited to this example; different grammars are possible as long as the parsing module 103 can understand the grammar.

Furthermore, for debugging and test purposes, a user may hope to control whether to include a specific module of the communication system to be simulated. The modern communication standards also leave a lot of options for the implementer to choose, for example, there are a lot of option features in 802.11n standards. Therefore, in the development of the simulation framework or prototyping, the user may hope to turn off a specific module temporarily. To support such a requirement, in each of the data structures, a switch filed is provided to specify whether the module corresponding to the data structure will be included. This feature is very useful for exploring the influence of impairments of a hardware module without having to achieve a new implementation of the transmitter or the receiver. For example, during simulation, a researcher may want to see how the modulation impairments, the nonlinearity of amplifier or the phase noise of the mixers will influence the performance of the simulated systems. By turning on and off the switches corresponding to those modules, the algorithm researcher can easily explore how they will influence the performance of system. All these can be done by simply changing the simulation configuration file 102.

After obtaining the simulation configuration file 102 by combining the user-defined and default configuration parameters, the parsing module 103 (see FIG. 1) will parse the simulation configuration file 102 by accessing the model library 104 to generate the instantiations of all the modules composed of the simulated system and then to form the final simulated system program 105. In this way, the user can switch different from one implementation of the same module to another at run-time. Below, the parsing process of the parsing module 103 will be described with reference to FIG. 4.

FIG. 4 shows the parsing process for a phase noise data structure 401, which is one of the data structures included in the simulation configuration file 102, as an example. The parsing processes of other data structures included in the simulation configuration file 102 are similar to that, and will not be described in more detail below.

As described above, the user can turn on and off certain modules by controlling the switch fields in the data structures. However, there are the cases that the structure of a new system can be totally different from the current simulated system. In the case, new implementations of the modules in the transmitter and receiver will be required. The parsing to the simulation configuration file 102 helps to switch different implementations of the same module at run-time seamlessly.

Referring to FIGS. 1 and 4, the phase noise data structure 401 is used as an example. The user can specify whether to use the measured phase noise model or use the theoretical phase noise model in the simulation through the configuration of the implementationhandle field of the phase noise data structure 401. Both of the measured phase noise model and the theoretical phase noise model are stored in the model library 104 and contain configuration parameters of different models, such as Fs, DBCLevel and CorFreq for the theoretical phase noise model and Fs, Filename and Offset for the measured phase noise model. In addition to the implementationhandle field, the phase noise data structure 401 also specifies the values of the configuration parameters. For example, for the theoretical phase noise model, the user can specify that the Fs is 20e 6 Hz, the DBCLevel is −90 dB/Hz and the CorFreq is 10 KHz, and for the measured phase noise model, the user can specify that the Fs is 20e6 Hz, the Filename is phasenoisefile and the Offset is equal to 0. By accessing the model library 104, the parsing module 103 can generate the desired instantiation of the mixer phase noise model, which specifies the desired phase noise implementation and includes the values of the configuration parameters for the desired implementation.

Similarly, for other modules composed of the communication system to be simulated, the parsing module 103 can select the specified implementations of these modules by parsing the simulation configuration file 102 and accessing the model library 104 and then generate the final simulated system program 105.

The user input 101 can be implemented in software, hardware, or firmware using any currently available user interface technology. The library 104 can be implemented in software or firmware using currently available database technology. The parsing module 103 can be implemented in software, hardware, or firmware using any currently available parsing technology.

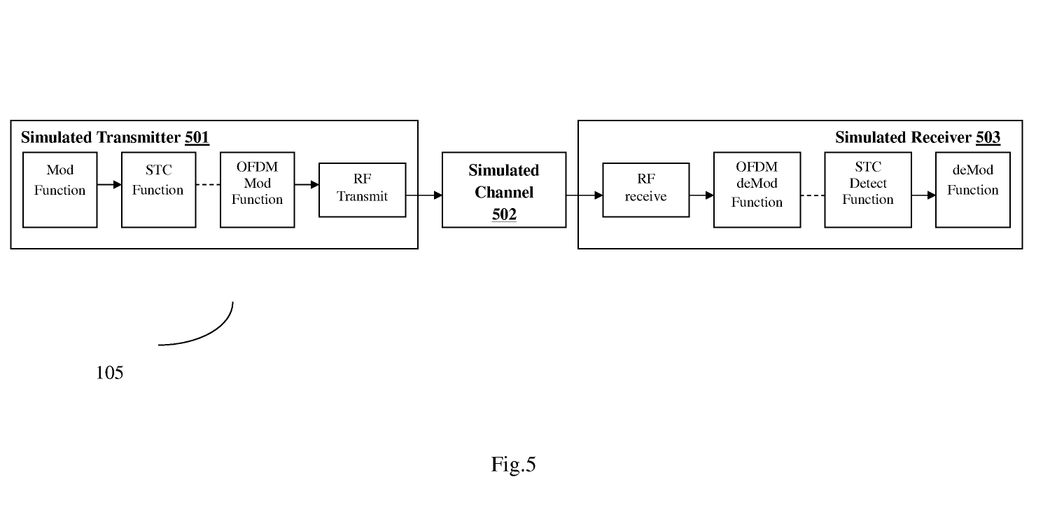

The structure of the simulated system program 105 is shown in FIG. 5. It can be seen that the simulated system program 105 corresponds to the structure of the simulation configuration file 102 and thus includes three main blocks, that is, the simulated transmitter 501, the simulated channel 502 and the simulated receiver 503. Each of the simulated modules 501-503 further includes a plurality of sub (or children) blocks.

After forming the simulated system program 105, the simulated system program 105 is loaded to the simulation engine 106 for simulation. Here, the simulated system program 105 is not fixed or “hard-coded” within the simulation engine 106 and can be configured by the user to adapt to different implementations of the simulated communication system.

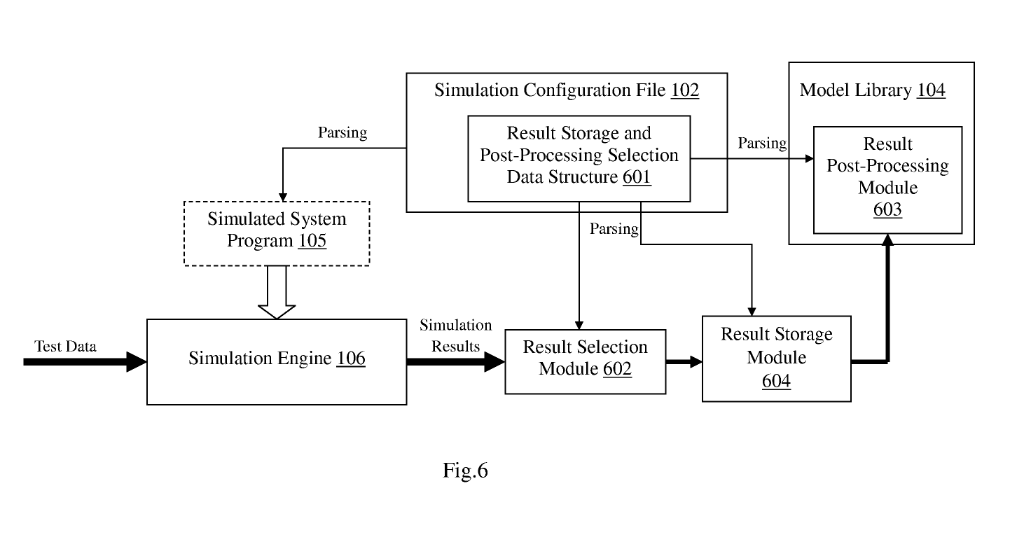

FIG. 6 shows the simulation result collection and post-processing process after simulation. In FIGS. 1 and 6, upon the simulated system program 105 is loaded into the simulation engine 106, the simulation engine 106 inputs the test data to the simulated system program 105, performs the simulation and outputs the simulation result. The test data can be generated randomly by a bit stream generator included in the configuration file or can be input from an external data input.

For the convenience of simulation result post-processing, such as the display or analysis of the simulation results, there needs to be a flexible approach for users to select what kind of simulation results to be collected and stored for post-analysis and which post-processing method to be used. The simulation system 100 in accordance with one embodiment of the present invention allows the user to specify a special data structure, namely, result storage and post-processing selection data structure 601, in the simulation configuration file 102. For every simulation, the user can specify in the result storage and post-processing selection data structure 601 what kind of simulation results to collect and for the collected data what kind of post-processing method to be performed. In FIG. 6, the simulation result from the simulation engine 106 is input to the result selection module 602. Under control of the result storage and post-processing selection data structure 601, the result selection module 602 selects the simulation results to be collected and sends them to the result storage module 604. The result storage module 604 is separate from the simulation configuration file 102 and is also specified by the result storage and post-processing selection data structure 601. After finishing simulation, the specified simulation results stored in the result storage module 604 are sent to the result post-processing module 603 for further processing, such as display or analysis. Here, the implementation of the result post-processing module 603 is also determined from the model library 104 by parsing with reference to the fields in the result storage and post-processing selection data structure 601. The result storage and post-processing program, i.e. the results selection module 602, the result storage module 604, and the result post-processing module 603 is configurable and reconfigurable. Such an approach reduces the memory requirement for result storage and enables flexible post-processing for the same collected data at run-time.

As shown in FIG. 6, since the simulation configuration file 102 contains all information on how to simulate the simulated system and all information on what to collect and how to analyze, the simulation engine 106 does not need to have any “hard-coded” parameters, which are dependent to a specific simulated system. This means that the simulation engine 106 can be decoupled with the simulated system program 105, and also decoupled with the simulation result collection and the post-processing method.

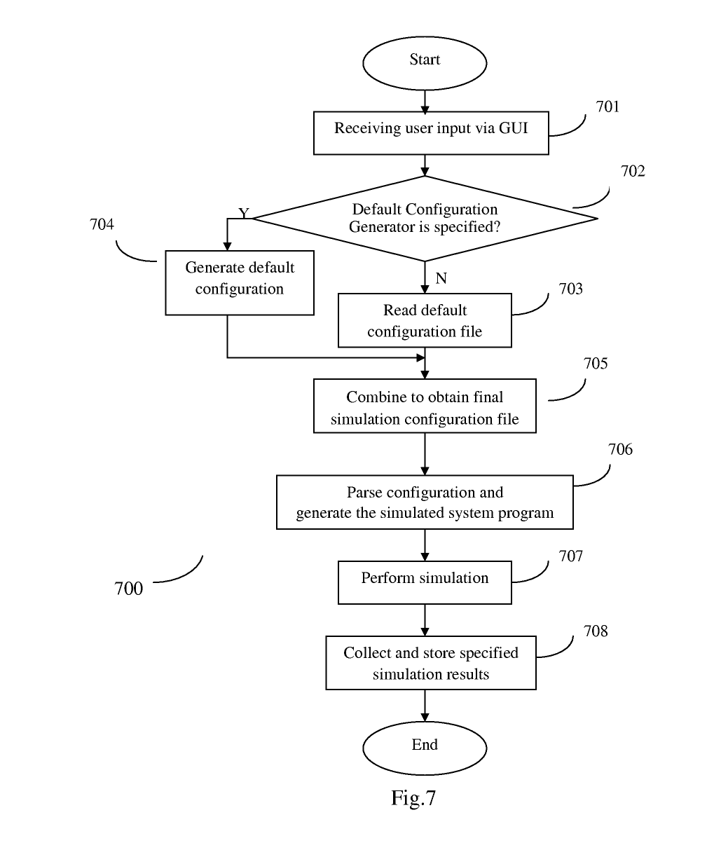

FIG. 7 is a flow chart diagram showing the operation process of the communication simulation system 100 of FIG. 1. In FIG. 7, the process begins with the user input of the system parameters via the user interface 101 to configure the user-defined configuration file 102A (701). Then, the user selects the generation approach of the default configuration parameters. In particular, at 702, the user determines whether a default configuration generator 102C is specified. If so, the default configuration generator 102C is performed to generate the default configuration file 102B (704). Otherwise, the user reads the default configuration file 102B stored in the simulation system directly to obtain the default parameters (703). After that, the user-defined configuration file 102A and the default configuration file 102B are combined at 705 to form the final simulation configuration file 102. Then, at 706, the parsing module 103 parses the simulation configuration file 102 by referring to the model library 104 to generate the simulated system program 105. The simulated system program 105 is loaded into the simulation engine 106 at 707 for simulation. After simulation, the user can select what kind of simulation results will be collected and store the specified simulation results into the simulation configuration file 102 for post-processing (708).

The capability of being able to use different implementations seamlessly at run-time results in flexibility and this flexibility is very helpful for the software and hardware co-simulation to achieve the capability of test and verification of hardware implementation. Therefore, this flexibility will help to facilitate the fast hardware prototyping.

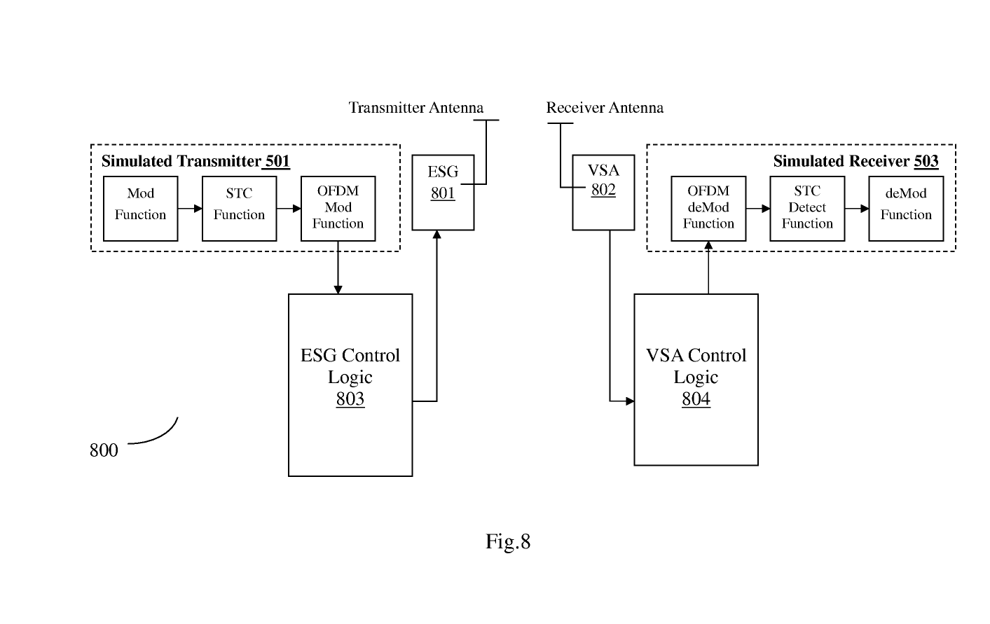

FIG. 8 shows a block diagram of an example of the software and hardware co-simulation performed by the communication simulation system 100 of FIG. 1. Compared with the software simulation framework shown in FIG. 5, which includes the simulated transmitter 501, the simulated channel 502 and the simulated receiver 503, in FIG. 8, the RF transmit module in the simulated transmitter 501 is replaced with an Electrical Signal Generator (ESG) 801 and its related ESG control logic 803, the RF receive module in the simulated receiver 503 is replaced with a Vector Signal Analyzer (VSA) 802 and its related VSA control logic 804, and the simulated channel 502 is achieved with the actual wireless channel. In this way, from FIG. 8, it can be seen that after integrating the ESG 801 and the VSA 802, by simply changing the simulation configuration file 102 to change the simulated system program 105 correspondingly, the communication simulation system 100 can be easily switched from the software simulation to a software and hardware co-simulation.

The software and hardware co-simulation based on the present invention has obvious advantages over traditional approaches: (1) the flexibility of ESG and VSA and the flexibility of the simulation system ensures the flexibility of implementing co-simulation of different systems. For example, the co-simulation system can easily adjust the working RF frequency. Through the change of simulation configuration file 102, the system can be easily tuned to work at different bandwidth, different base-band system structure; (2) the user needs only focus on the software algorithms and does not need to pay much attention on the implementation of RF front-ends, which greatly saves the time and lowers down the cost; and (3) the software and hardware co-simulation system is standard independent. This is due to the standard independence of software simulation framework and the software defined radio structures of the instruments. The user can switch between different standards at run-time as long as those standards are implemented on the simulation system.

In FIG. 8, for illustration purpose, the ESG and VSA from Agilent Technologies Inc. are used as RF hardware for software and hardware co-simulation. However, the disclosure is not limited to ESG and VSA. Any RF hardware, which can realize base-band to RF up-conversion and RF to base-band down-conversion, and which can be controlled through software interface to perform such conversions, can be used to realize the software and hardware co-simulation.

In addition to the RF transmit module and the RF receive module, other modules composed of the communication system to be simulated, such as the modulator, the encoder, the MIMO detector, etc. can be replaced with corresponding hardware implementations in the same way to achieve the capability of verification. For a specific module to be verified (for example, a modulator), the modules before it can be just simplified to be a module which loads data to the input interfaces of the module to be verified, and the modules after the specific module can be simplified to be a module which collects data from the output interface of the module to be verified. In this way, the user can easily load the test vectors used to test the corresponding hardware function module (for example, the corresponding hardware modulator) to the simulated module (the simulated modulator) and then compare the output data at output interfaces of both the simulated module and the corresponding hardware function module. This approach can help accelerate the test and verification of hardware implementation and thus the hardware prototyping.

As a quick summary, the present invention discloses a flexible communication simulation system and method, which, by decoupling the simulated system program with the simulation engine, enables flexible and scalable simulation of different communication systems on the same simulation framework seamlessly at run-time. Furthermore, due to the advantages of the simulation configuration file architecture and the configuration approach, the communication simulation system of the present invention is able to specify the simulation results to be collected and the post-processing approach at run-time, and can accelerate the test and verification of hardware implementation by hardware and software co-simulation, so as to facilitate the fast hardware prototyping.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A simulation system for a communication system, comprising:
a user interface to receive user definition and system configuration parameters of a simulation configuration file that includes a plurality of data structures representing various functional modules of the simulated communication system;
a model library to store different implementation models corresponding to different communication standards for each of the functional modules;
a parsing module (1) to access the model library according to the user definition and system configuration parameters to obtain the appropriate implementation model for each of the functional modules, and (2) to generate a simulated system program based on the selected implementation models such that the simulated system program is reconfigurable to different implementations and communication standards; and
a simulation engine to run the simulated system program to simulate the simulated communication system.

2. The simulation system of claim 1, further comprising a store to store the simulation configuration file that includes a user-defined configuration file and a default configuration file, wherein the simulation system further comprises a default configuration generator that generates the default configuration file.

3. The simulation system of claim 1, wherein each of the data structures comprises an implementationhandle field for specifying the implementation model of the functional module represented by the data structure.

4. The simulation system of claim 1, wherein each of the data structures comprises a switch field for turning on and off the functional module represented by the data structure in the simulated system program.

5. The simulation system of claim 1, wherein each of the data structures comprises an index for indicating all of the ancestor data structures.

6. The simulation system of claim 1, wherein the simulated system program includes a plurality of program blocks corresponding to the layered data structures of the simulation configuration file.

7. The simulation system of claim 1, further comprising a store to store a result storage data structure that specifies the simulation results to be collected and the post-processing methods for the collected simulation results, and stores the selected simulation results.

8. The simulation system of claim 7, further comprising a result selection module to select the simulation results to be collected according to the configuration parameters included in the result storage data structure.

9. The simulation system of claim 8, further comprising a result post-processing module to post-process the simulation results in the result storage data structure.

10. A system for generating a simulated system program for simulating a communication system, comprising:
a user interface to receive user definition and system configuration parameters of a simulation configuration file that includes a plurality of data structures representing various functional modules of the simulated communication system;
a model library to store different implementation models corresponding to different communication standards for each of the functional modules;
a parsing module to access the model library according to the user definition and system configuration parameters to obtain the appropriate implementation model for each of the functional modules, and to generate the simulated system program based on the selected implementation models such that the simulated system program is reconfigurable to different communication standards.

11. The system of claim 10, further comprising a store to store the simulation configuration file which includes a user-defined configuration file and a default configuration file, wherein the simulation system further comprises a default configuration generator that generates the default configuration file.

12. The system of claim 10, wherein each of the data structures comprises an implementationhandle field for specifying the implementation model of the functional module represented by the data structure.

13. The system of claim 10, wherein each of the data structures comprises a switch field for turning on and off the functional module represented by the data structure in the simulated system program.

14. The system of claim 10, wherein each of the data structures comprises an index for indicating all of the ancestor data structures.

15. The system of claim 10, wherein the simulated system program includes a plurality of program blocks corresponding to the layered data structures of the simulation configuration file.

16. The system of claim 10, further comprising a store to store a result storage data structure that specifies the simulation results to be collected and the post-processing methods for the collected simulation results, and stores the selected simulation results.

17. The system of claim 16, further comprising a result selection module to select the simulation results to be collected according to the configuration parameters included in the result storage data structure.

18. The system of claim 17, further comprising a result post-processing module to post-process the simulation results in the result storage data structure.
